(19) United States
(12) Patent Application Publication
(10) Pub. No.: US 2026/0176032 A1
(43) Pub. Date: Jun. 25, 2026

(54) ENHANCED CONTAINER AND RACK SYSTEM FOR OPERABILITY AND STORAGE

(71) Applicant: Modern Ink, LLC, Lewes, DE (US)

(72) Inventors: Louis J. Rubino, Jr., York, SC (US); Tyler Do, Burbank, CA (US)

(21) Appl. No.: 19/431,384

(22) Filed: Dec. 23, 2025

Related U.S. Application Data
(60) Provisional application No. 63/738,121, filed on Dec. 23, 2024.

(51) Int. Cl. B65D 47/08; B65D 23/00

(52) U.S. Cl. CPC B65D 47/0885; B65D 23/001

(57) ABSTRACT

An ink container may include a body, configured to hold tattoo ink in an interior of the body, where the body comprises an opening through a neck of the body, and a cap attached to the neck. The cap is attached to the neck with a fulcrum joint, where in response to a first force on a first portion of the cap, a second portion of the cap lifts to uncover the opening to the body, allowing the tattoo ink to flow out of the body through the neck.

### CROSS REFERENCE TO RELATED APPLICATION

This application claims the benefit of U.S. Provisional Application No. 63/738,121, filed Dec. 23, 2024, which is incorporated by reference herein in its entirety.

### FIELD

Embodiments of the present disclosure relate generally to a container for a liquid. More particularly, embodiments of the disclosure relate to a container and container system for carrying a liquid (e.g., tattoo ink, dyes, permanent makeup, etc.) and storage of the containers.

### BACKGROUND

A permanent tattoo is a form of body modification made by injecting tattoo ink into a person's skin. A tattoo artist may create these designs using various tattooing equipment through one or more tattooing processes in which the tattoo artist injects the ink into the subject.

Tattoo inks consist of pigments combined with a carrier, used in the process of tattooing to create a tattoo in the skin. Tattoo inks are typically a liquid that includes a mixture of solid particles of pigment, molecular dyes and binders suspended in a water solution. The color comes from light either being reflected from or absorbed by the particles and dyes.

During a tattooing process, ink may be housed in a container. It may be beneficial for a container to be easily wielded (e.g., opened and closed) with one hand, and to have features that reduce contamination and improve convenience when picking up and putting down the container.

### SUMMARY

In an aspect, a container is disclosed. The container may contain tattoo ink, pigments, dyes, permanent makeup, or other similar ink-like liquids. The ink container may include a body, configured to hold tattoo ink in an interior of the body, wherein the body comprises an opening through a neck of the body. The ink container further includes a cap attached to the neck, where the cap comprises a first portion and a second portion, pivoting about a fulcrum, wherein in response to a force on the first portion, the second portion of the cap moves (e.g., in a direction opposite of the force) to uncover the opening to the body, allowing the tattoo ink to flow out of the body through the neck.

In an embodiment, the neck comprises a tab, arranged on the neck to hold the second portion of the cap to cover the opening to the body. The tab may comprise an arc shape or semi-circle. The tab may be at least 0.5 mm in height, or at least 1 mm in height, or at least 2 mm in height. The tab may be at least 3 mm in length, or at least 20 mm in length, or at least 25 mm in length. The arc shape or semi-circle shape may be complementary in shape to an internal wall of the cap.

In an embodiment, the neck comprises an elongated spout that extends from the neck and into a recess of the cap when the cap is in a closed position. The spout comprises a height of at least 2.5 mm, or at least 4 mm. In an embodiment, the spout comprises an opening of at least 3 mm in diameter, or at least 4 mm in diameter.

In an embodiment, the cap comprises a collar that is raised on an interior surface within the recess. In an embodiment, the collar is complementary in shape with an opening of the spout, and aligned in position with the spout to seal the opening of the spout when the cap is in the closed position.

In an embodiment, the fulcrum may be statically fixed to the neck, and comprises at least one bracket with a pin or socket that mates with a second socket or second pin of the cap, wherein the cap is rotatable about the at least one bracket. In an embodiment, the at least one bracket comprises a first bracket fixed to the neck and a second bracket fixed to the neck. In an embodiment, the first bracket and the second bracket are parallel to each other.

In an embodiment, the first portion of the cap comprises a downward sloping surface and the second portion of the cap comprises a horizontal surface. In an embodiment, the first portion (e.g., the sloping surface) comprises a length of at least 5 mm, or at least 8 mm, or at least 10 mm.

In an embodiment, the body comprises one or more grooves arranged along a vertical axis of the ink container. In an embodiment, the one or more grooves comprises a first groove and a second groove, the first groove being arranged on a first side of the body, the second groove being arranged on a second side of the body, wherein the first side and the second side are opposite facing. In an embodiment, a bottom end of each of the first groove and the second groove is open at a bottom edge of the body. In an embodiment, a top end of each of the first groove and the second groove come to a respective stop formed by a surface at an inner region of the body.

In an embodiment, the one or more grooves are complimentary in shape to one or more one or more tongues that are vertically aligned on a rack, to hold the ink container with a vertical orientation on the rack.

In an embodiment, a base of the body comprises a round side between the first side and the second side, and a flat edge between the first side and the second side, wherein the flat side is located opposite of the round side. In an embodiment, the second portion of the cap is located on a same side of the ink container as the flat side, and the first portion of the cap is located on a same side of the ink container as the round side.

In an embodiment, a total height of the ink container comprises a range of 50 mm to 90 mm, or a range of 60 mm to 80 mm, or a range of 70 mm to 75 mm. The dimensions of the ink container may be optimized to sit comfortably in the palm of a human hand (e.g., of average size) so that the cap is positioned advantageously to be accessible to the user's thumb to apply the force on the cap.

In an embodiment, the neck and the body comprise a single monolithic form and the cap comprises a second single monolithic form.

In an aspect, a system is described, that includes one or more ink containers, and a rack that holds the one or more ink containers. Each ink container may comprise a body configured to hold tattoo ink in an interior of the body, where the body comprises an opening through a neck of the body, and where the body comprises one or more grooves arranged along a vertical axis of the ink container. The rack is configured to hold the ink container, where the rack comprises one or more tongues that are complimentary in shape to the one or more grooves, the one or more tongues being vertically aligned on the rack, to hold the ink container with a vertical orientation on the rack.

In an embodiment, the rack comprises a plurality of positions to hold a plurality of ink containers. In an embodiment, in each of the plurality of positions, the one or more tongues comprise two opposing tongues that are arranged to mate with two grooves of a respective one of the plurality of ink containers.

In an embodiment, the rack comprises a base surface configured to hold the rack upright on a horizontal surface. Additionally, or alternatively, the rack comprises a mounting hole or stud, configured to mount the rack onto a vertical surface.

Other technical features may be readily apparent to one skilled in the art from the following figures, descriptions, and claims.

### DESCRIPTION OF THE DRAWINGS

The aspects are illustrated by way of example and not by way of limitation in the drawings in which like references may indicate similar elements. It should be noted that reference to “an” or “one” aspect of this disclosure are not necessarily to the same aspect, and they mean at least one. Also, in the interest of conciseness and reducing the total number of figures, a given figure may be used to illustrate the features of more than one aspect, and not all elements in the figure may be required for a given aspect. It should be understood that some of the embodiments shown may be combined with other embodiments even if not shown as such in each figure.

FIG. 1 illustrates an example container with cap closed, in accordance with an embodiment.

FIG. 2 illustrates an example container with cap open, in accordance with an embodiment.

FIG. 3 illustrates an example container from a back perspective view with cap closed, in accordance with an embodiment.

FIG. 4 illustrates an example container from a front perspective view with cap open, in accordance with an embodiment.

FIG. 5 illustrates an example container from a front view with cap open, in accordance with an embodiment.

FIG. 6 illustrates an example container from a top view with cap open, in accordance with an embodiment.

FIG. 7 illustrates an example container from a bottom view, in accordance with an embodiment.

FIG. 8 illustrates an example container from a side view with cap open, in accordance with an embodiment.

FIG. 9 illustrates an example container from a side view with cap closed, in accordance with an embodiment.

FIG. 10 illustrates an example system comprising a container and container rack, in accordance with an embodiment.

FIG. 11 illustrates an example system comprising a container and a container rack from a front view, in accordance with an embodiment.

FIG. 12 illustrates an example system comprising a container and a container rack from a front perspective view, in accordance with an embodiment.

FIG. 13 illustrates an example system comprising a container and a container rack from a front view, in accordance with an embodiment.

FIG. 14 illustrates an example system comprising a container and a container rack from a front perspective view, in accordance with an embodiment.

### DETAILED DESCRIPTION

The tattooing process may be a lengthy one. Throughout a tattoo process, a tattoo artist may operate multiple handheld tools (e.g., a tattoo pen, wipes, ink vessels, etc.), while also adjusting tables, stands, chairs, armrests, etc., and doing so while maintaining a sanitary environment. As such, it is desirable to provide tattoo equipment that reduces the manual effort on the part of the tattoo artist, such as by making some devices that are capable of operation with a single hand, and with reduced steps and physical strain.

Tattoo artists may make use of different colored inks during the tattoo process. Tattoo ink is typically a mixture of pigments, binders, and molecular dyes suspended which are suspended in a liquid carrier. The carrier acts as a solvent for the pigment, to carry the pigment from the needle insertion point to the user's skin (e.g., the epidermis and/or dermis). Carriers keep the ink mixed and sanitary, while aiding in the transport of the pigment. Typical carriers include ethyl alcohol, distilled water; methanol, propylene glycol, glycerin denatured alcohol, or isopropyl alcohol. Different colored tattoo ink may be stored in respective ink containers, for the tattoo artist to access (e.g., open and close) as-needed during the tattoo process.

Currently, ink containers typically require two hands to open (e.g. twist caps or difficult to operate flip caps). Additionally, even if some existing flip cap ink containers can be opened and closed with a single hand, this may require significant force and strain due to the design of the container. Further, such containers may not have design features that reduce risk of cross contamination or cleanliness. For example, current containers may spray or leak ink onto a user's finger (e.g., a thumb) when opening the flip cap. Additionally current containers are lacking an integrated and effective means of storage, transport, and packing. Typically, these containers are loosely stored in a workstation drawer or thrown into a bag and/or case when traveling.

Aspects of the present disclosure relate to a container for pigments such as, for example, tattoo ink, permanent makeup, etc. The container has integrated features such as, for example, a lever actuated, opening mechanism for single handed operation and improved cleanliness; and mounting feature integrated as part of the bottle geometry, that allows the bottle to be mounted to supplementary, rails, stands, mounts, etc. With the integrated rail system, the container is adaptable to mount on a rack that may be integrated with a workstation, drawer mounting, wall mounts, travel cases, or other systems that may utilize the mounting rack for effective, clean, and organized storage and transport of the ink containers.

In an aspect, a container is disclosed. The container may contain tattoo ink, pigments, dyes, permanent makeup, or other similar ink-like liquids. The ink container may include a body, configured to hold tattoo ink in an interior of the body, wherein the body comprises an opening through a neck of the body. The ink container further includes a cap attached to the neck, where the cap comprises a first portion and a second portion, that pivot about a fulcrum. In response to a force on the first portion, the second portion of the cap lifts to uncover the opening to the body, allowing the tattoo ink to flow out of the body through the neck.

In an aspect, a system is described, that includes one or more containers, such as described above, and a rack that holds the one or more ink containers. Each ink container may comprise a body configured to hold tattoo ink in an interior of the body, where the body comprises an opening through a neck of the body, and where the body comprises one or more grooves arranged along a vertical axis of the ink container. The rack is configured to hold the ink container, where the rack comprises one or more tongues that are complimentary in shape to the one or more grooves, the one or more tongues being vertically aligned on the rack, to hold the ink container with a vertical orientation on the rack.

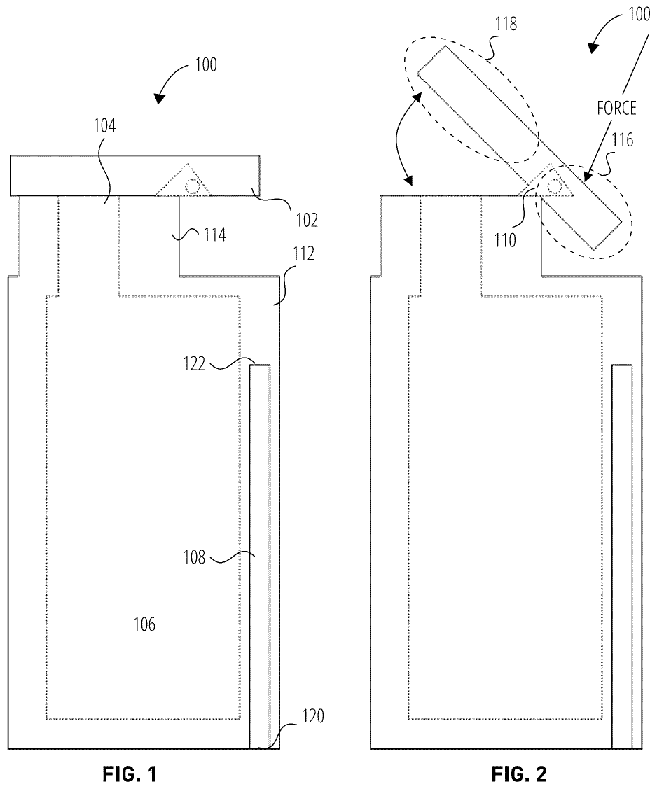

FIG. 1 shows an example liquid container, in accordance with an embodiment. Liquid container 100 may comprise features that allow for one-handed opening and closing of the container with reduced effort, and with anti-contamination features that reduce the risk of the container contents from inadvertently spraying or leaking.

FIG. 1 shows a side view of container 100, which may be referred to as an ink container or tattoo ink container. The container 100 may include a body 112, configured to hold a liquid (e.g., an ink, tattoo ink, permanent makeup, etc.) in an interior cavity 106 of the body 112. The body 112 comprises an opening 104 through a neck 114 of the body. The neck may comprise a channel that fluidly connects the opening 104 to the interior cavity 106 of the container 100. The ink container 100 further includes a cap 102 attached to the neck 114.

FIG. 2 shows an example of the liquid container 100 with the cap 102 in the open position, while FIG. 1 shows the cap 102 in the closed position. The cap 102 comprises a first portion 116 and second portion 118 which pivot about a fulcrum 110. The cap 102 is mechanically coupled to the fulcrum and, in response to a force (e.g., a downward force) on the first portion 116, a second portion 118 of the cap moves (e.g., upward) to uncover the opening 104 to the body, allowing the tattoo ink to flow out of the body through the neck.

In an embodiment, the fulcrum 110 comprises at least one bracket. The bracket may comprise an axis where the cap 102 attaches via a pivoting fixture (e.g., ball and socket, pin and socket, pin and groove, etc.), such that the cap 102 is rotatable about fulcrum 110.

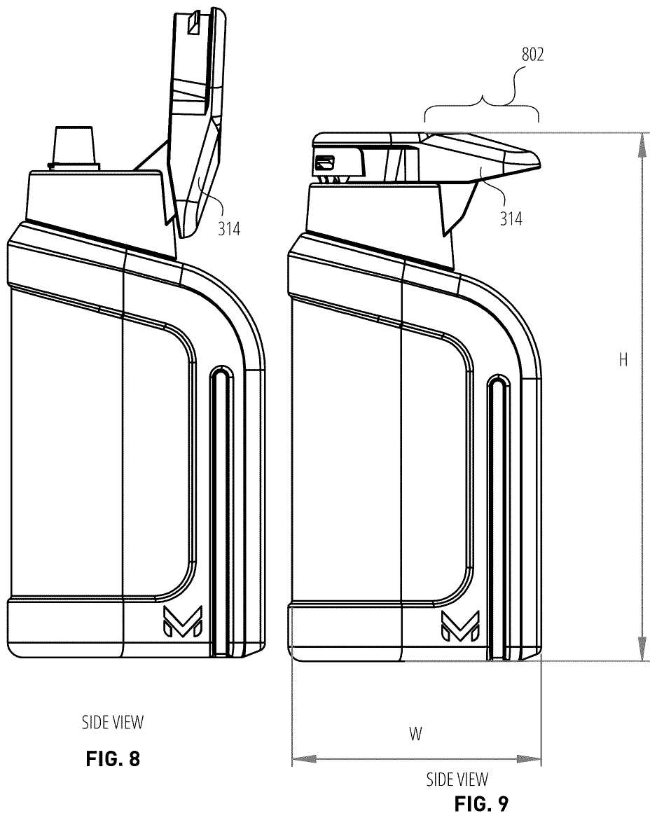

In an example, fulcrum 110 may be statically fixed to the cap 102, and then dynamically fixed to the neck 114 through the pivoting fixture, or vice versa. For example, in the case where the fulcrum 110 is statically fixed to the cap 102, the at least one bracket may be statically fixed to or integral to the cap 102, and then connects to and pivots on the neck 114, with the result being the same—the downward force opens the cap 102 through the pivoting motion of the cap 102. Otherwise, the fulcrum 110 may be integral to the neck 114, and the cap may comprise one or more mechanical features (e.g., arms, brackets, pin, socket, etc.) that mate to the axis of the fulcrum 110 with a rotatable motion. In an embodiment, each fulcrum 110 extends out of or is fixed to a top surface of the neck 114, and is also fixed to or extends out of a side surface of the neck 114, as shown, for example, in fulcrum 404 and 402 in FIG. 4 and FIG. 8, to provide additional mechanical support for the fulcrum from forces in lateral and vertical directions.

In an embodiment, the first portion 116 may have a length that extends past the fulcrum 110 and the neck 114 so that the when the first force (e.g., a downward force) is acted on it, sufficient torque is generated from the length to overcome a locking mechanism that holds the cap 102 onto the neck 114.

In an embodiment, the body 112 comprises one or more grooves 108 arranged along a vertical axis of the ink container 100. In an embodiment, a bottom end 120 of each of the one or more grooves is open at a bottom edge of the body 112. In an embodiment, a top end 122 of each of the one or more grooves 108 come to a respective stop formed by a surface at of the body 112 away from the edge. The one or more grooves may be recessed from the surface of body 112 by a distance to sufficiently secure the container 100 on the rack (e.g., greater than 1 mm, or greater than 2 mm). This allows for a user to conveniently slide the container 100 onto one or more respective tongues of a rack (not shown here), by aligning the one or more grooves 108 with the one or more respective tongues of the rack, and allowing gravity, friction, and inertia to hold the container 100 in place on the rack.

Although FIG. 1 and FIG. 2 show one or more example embodiments of an ink container, it should be understood that there may be different embodiments than that which is shown, such as different shapes or dimensions, and different features, which are within the scope of the present disclosure.

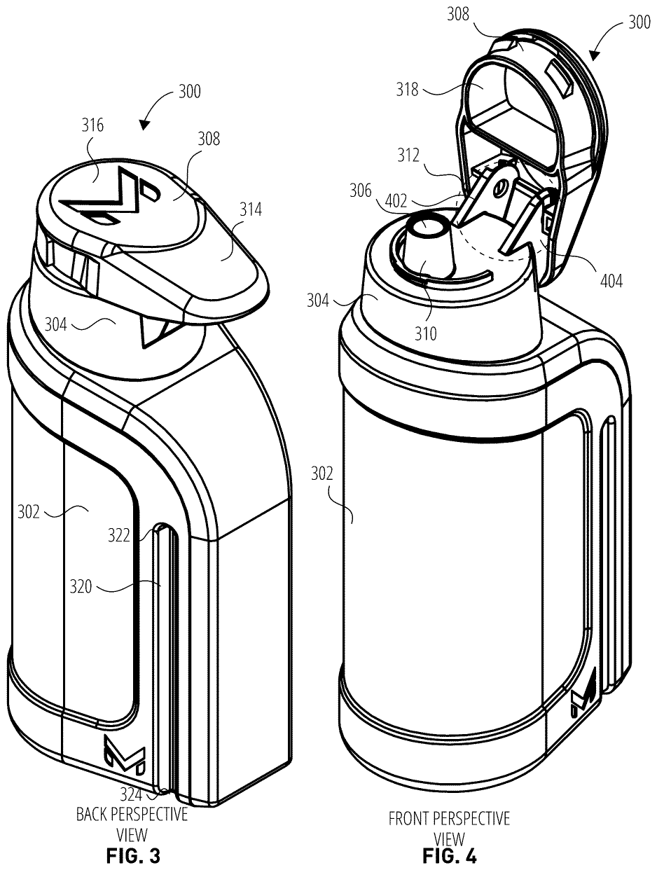

FIG. 3-FIG. 9 shows an example liquid container, in accordance with an embodiment. Liquid container 300 has features that emphasize one-handed opening and closing of the container with reduced effort, and with anti-contamination features that reduce the risk of the container contents from inadvertently spraying or leaking.

Container 300 may be an embodiment of container 100. Although FIG. 3 through FIG. 9 shows one or more example embodiments of an ink container, it should be understood that there may be different combinations of features than that which is shown, or different shapes or dimensions, which remain within the scope of the present disclosure.

FIG. 3 and FIG. 4 show different perspective views of container 300, in accordance with an embodiment. In FIG. 3, the container 300 is shown with cap 308 in a closed position, and in FIG. 4, the container 300 is shown with cap 308 in the open position.

Container 300 may be referred to as an ink container. The ink container 300 may include a body 302, configured to hold a liquid (e.g., an ink, tattoo ink, permanent makeup, etc.) in an interior part of the body 302 (e.g., a cavity). The body 302 comprises an opening 306 through a neck 304 of the body 302.

The cap 308 is attached to the neck 304 with a fulcrum 312 (e.g., a fulcrum joint), which permits the cap 308 to pivot and rotate about an axis (e.g., a pivot point or fixed axis) thereby opening the container 300 by exposing the otherwise covered opening 306 when the cap 308 is pressed upon and actuated. For example, the cap 102 may comprise a first portion 314 that is mechanically coupled to fulcrum 312 and, in response to a first force on the first portion 314, a second portion 316 of the cap lifts to uncover the opening 306 to the body, thereby allowing the contents of the container 300 to flow out of the body through the opening 306.

The first portion 314 may have a sufficient length and/or surface area upon which the force is exerted to sufficiently spread the force so that a user does not experience discomfort (e.g., on the user's finger or thumb). In an embodiment, the first portion 314 comprises a length 802 (see FIG. 9) of at least 5 mm, or at least 8 mm, or at least 10 mm. In an embodiment, the first portion 314 of the cap comprises a downward sloping surface and the second portion of the cap comprises a horizontal surface, when cap 308 is in the closed position.

In an embodiment, the cap 308 may open at least to a 90 degree angle, or in some embodiments, to greater than a 90 degree angle, relative to when it is in the closed position, as shown, for example, in FIG. 8. In such a manner, the cap 308 gives sufficient clearance to the contents as it exits the opening 306.

In an embodiment, the neck comprises an elongated spout 310 that extends from the neck 304. In an embodiment, the elongated spout 310 may extend into a recessed cavity 318 of the cap 308, when the cap 308 is in a closed position. The spout 310 may provide improved cleanliness and control of the contents of the container as it exits. In an embodiment, the spout comprises a height of at least 2.5 mm, or at least 4 mm. In an embodiment, the spout comprises an opening of at least 3 mm in diameter, or at least 4 mm in diameter.

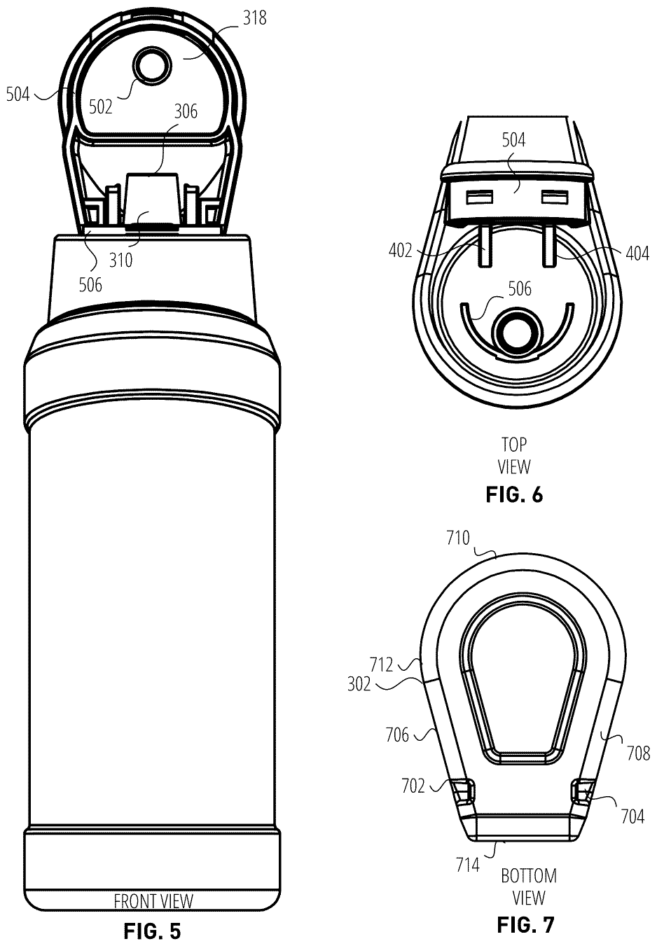

The spout 310 may serve to seal to contents in the container when the cap is closed, and reduce spray when the cap 308 is opened with force. For example, as shown in FIG. 5, in an embodiment, the cap comprises a collar 502 that is raised on an interior surface of the cap 308 within the recess 318 that the spout 310 resides in when the cap 308 is closed. In an embodiment, the collar 502 is complementary in shape with the opening of the spout, and aligned in position with the spout 310 to seal the opening 306 of the spout when the cap is in the closed position. For example, collar 502 may comprise a raised ring-shaped edge that fits tight against and within the opening 306 when the cap 308 is closed, thereby preventing the contents from spilling out within the recessed cavity 318.

In an embodiment, the recessed cavity 318 comprises a D-shaped recess. The round portion of the D-shape may face toward the direction that the cap 308 opens, and the flat portion of the D-shape may face the opposite direction (e.g., at where the cap 308 pivots). The D-shaped recess bay be formed by one or more sidewalls 504 of the cap 308. The fulcrum 312 may be positioned behind the flat side of the D-shape, which gives the fulcrum 312 sufficient space to reside and pivot the cap 308.

In an embodiment, the neck comprises a raised tab 506, arranged on the neck 304. This raised tab 506 is configured on the neck 304 to apply a holding force to the cap 308 when the cap is in a closed position. For example, the tab 506 may be jointly coupled to the interior of sidewalls 504. In an embodiment, the tab 506 may couple with the round portion of the D-shaped recessed cavity 318. In an embodiment, the tab 506 may comprise an arc shape or semi-circle, which may be complementary in shape to the round portion of the D-shaped recessed cavity 318. In an embodiment, the tab may be at least 0.5 mm in height, or at least 1 mm in height, or at least 2 mm in height. The tab may be at least 3 mm in length, or at least 20 mm in length, or at least 25 mm in length, depending on how much holding force is desired and the size of the recessed cavity 318.

In an embodiment, the fulcrum comprises at least one bracket (e.g., 402, 404 shown in FIG. 4) with a pin or socket mating interface. For example, the bracket may comprise a first pin or socket that mates with a second socket or second pin which may be fixed on the cap, or vice versa (e.g., if the bracket is integral to or statically fixed to the cap 308, then it may mate with a pin or socket on the neck 304). The pin or socket serves as the pivoting point for the fulcrum pivot 312. Regardless of the variety of different fulcrum pivots 312 that may be implemented, the cap 308 is coupled to the neck 304, and is rotatable about the at least one bracket (e.g., at the pivot point).

In an embodiment, the at least one bracket comprises a first bracket 402 is fixed to the neck and a second bracket 404 is fixed to the neck. In an embodiment, the first bracket 402 and the second bracket 404 are parallel to each other (see, for example, FIG. 4 and FIG. 6).

In an embodiment, the body comprises one or more grooves 320 arranged along a vertical axis of the ink container 300. The one or more grooves 320 are complimentary in shape to one or more one or more tongues that are vertically aligned on a rack (not shown in FIG. 3-FIG. 9), to hold the ink container with a vertical orientation on the rack.

In an embodiment, the one or more grooves 320 comprises a first groove 702 and a second groove 704 (see FIG. 7). The first groove 702 may be located on a first side 706 of the body 302. The second groove 704 may be located on a second side 708 of the body 302. The first groove 702 and the second groove 704 may be opposite facing, which may help secure the bottle when the grooves mate with respective tongues, by being held on opposing sides. In an embodiment, a top end 322 of the one or more grooves 320 (e.g., the first groove and the second groove) come to a respective stop formed by a surface of the body away from the body edge). In such a manner, the wall of the body serves as a limit stop for how far the tongue travels up the one or more grooves 320.

In an embodiment, as shown in FIG. 7, a base 712 of the body 302 comprises a round side 710 located between the first side 706 and the second side 708, and a flat side 714 located between the first side 706 and the second side 708. The flat side 714 is located opposite of the round side 710. In an embodiment, the second portion of the cap (e.g., the part that is pressed on) is located on the same side of the ink container as the flat side 714. This may be referred to as a back side of the container. The first portion of the cap is located on the same side of the ink container as the round side 710. This may be referred to as the front, because this is where the mouth of the cap opens. In an embodiment, a bottom end of each of the first groove 702 and the second groove 704 is open at a bottom edge 324 of the body 302.

In an embodiment, a total height H (e.g., a bottom facing region) of the ink container comprises a range of 50 mm to 90 mm, or a range of 60 mm to 80 mm, or a range of 70 mm to 75 mm. In an embodiment, a width of the body 302 may comprise a range of 25 mm to 40 mm, or 30 mm to 38 mm, or 33 mm to 36 mm.

In an embodiment, the neck and the body comprise a single monolithic form. For example, the neck and body may be formed from a continuous material (e.g., a plastic, or polymer blend). Additionally, or alternatively, the cap comprises a second single monolithic form, such as also being formed from a single continuous material such as plastic or polymer blend. This may reduce the complexity of the manufacturing for the container, while also aiding in the recyclability of the container.

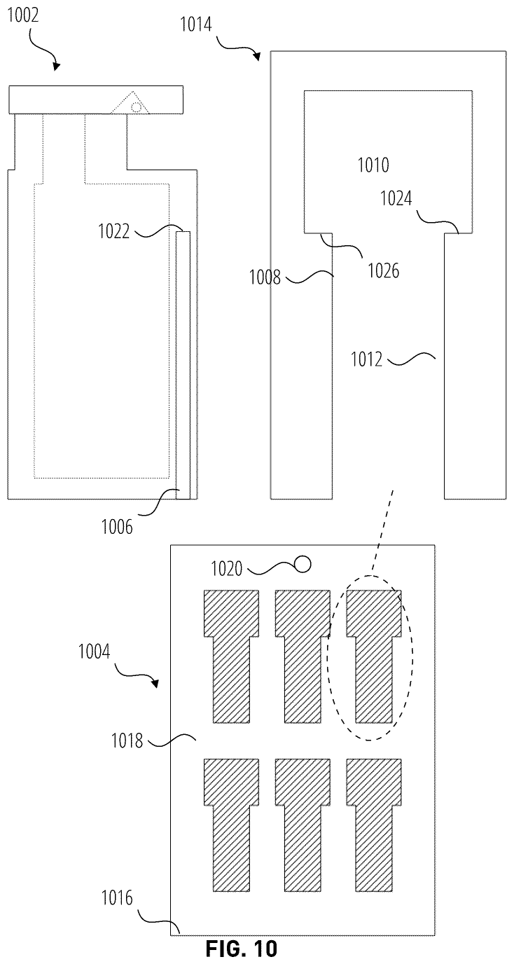

FIG. 10 shows an example system comprising a container and container rack, in accordance with an embodiment. The container 1002 and container rack 1004 may comprise features to hold container 1002 in a secure yet accessible manner.

Container 1002 may comprise any of the features described with respect to container 100 and container 300. Container 1002 may be referred to as an ink container (e.g., containing tattoo ink, makeup, paint, ink, etc.).

Container 1002 may be one of a plurality of containers, each comprising a body configured to hold tattoo ink in an interior of the body, where the body comprises an opening through a neck of the body, as described in other sections. The body comprises one or more grooves 1006 arranged along a vertical axis of the container 1002.

The rack 1004 is configured to hold the container 1002. The rack comprises one or more tongues (e.g., 1008, 1012) that are complimentary in shape and position to the one or more grooves 1006. The one or more tongues (1008, 1012) may be vertically aligned on the rack, to hold the ink container with a vertical orientation on the rack.

In an embodiment, the rack comprises a plurality of positions (e.g., 1014) to hold a plurality of containers such as 1002. In an embodiment, in each of the plurality of positions, the one or more tongues comprise two opposing tongues 1008 and 1012, that are arranged to mate respectively with two grooves (e.g., on opposite sides of container 1002). In an embodiment, each position 1014 may comprise a clearing space 1010 above the opposing tongues 1008, 1012, which has a size and shape sufficient to insert and remove the container 1002 from the position 1014. Each groove 1006 may comprise a limit stop 1022 which mechanically abuts against a top edge (1024, 1026) of each corresponding tongue, respectively.

In an embodiment, the rack comprises a base surface 1016 configured to hold the rack upright on a horizontal surface. The base surface 1016 may comprise an angled base or L shape that extends from the face 1018 of the rack, to support the rack on a surface (e.g., a table top, a stand, etc.). Additionally, or alternatively, the rack comprises one or more mounting holes or studs 1020, configured to mount the rack onto a vertical surface (e.g., a wall). Other mechanical features such as, for example, stand offs, adjustable feet, brackets, etc., may be part of the rack 1004 to aid in mounting or stability.

In an embodiment, the container in any of the example containers disclosed may comprise a safety seal such as, for example, a tab that is fixed to the cap and the neck to prevent the cap from opening. The tab may be a tear-away tab that, once removed, allows the cap to open, but is permanently removed. In an embodiment, the contents of the container is housed in the container, with the safety lock applied, to prevent tampering. For example, the container may comprise a tattoo ink, permanent makeup, etc., that is sealed within the container thereby preventing tampering of the contents until ready to use.

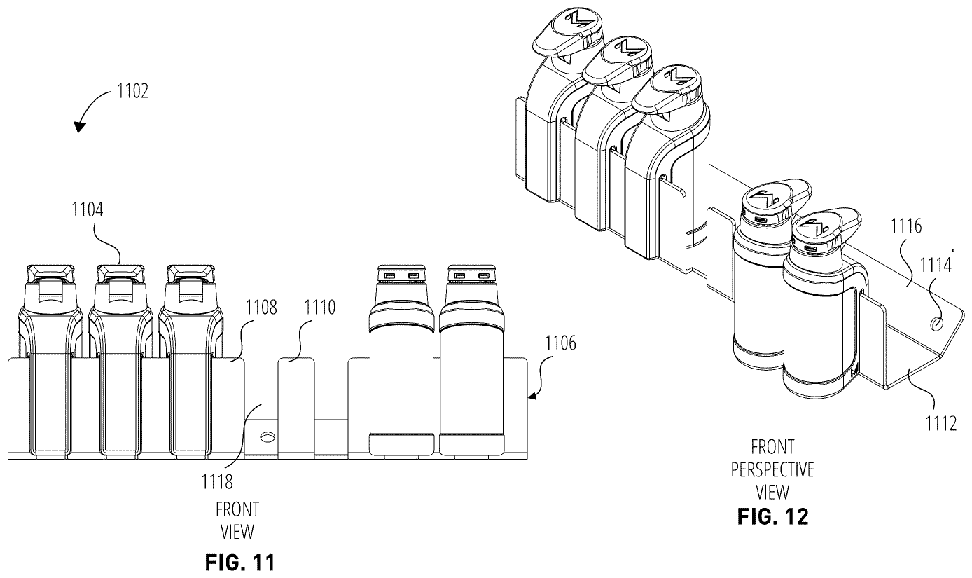

FIG. 11 and FIG. 12 show an example container and rack system 1102, in accordance with an embodiment. In an embodiment, the system may comprise a rack 1106 with side by side tongues 1108, 1110, separated by an opening 1118, having a size and shape to accommodate a vertical placement of one or more container 1104. Each of the one or more containers comprise opposing grooves that are arranged to mate with the respective tongues 1108, 1110, as described, to hold the respective container 1104 as it occupies the space in the opening 1118. The rack 1106 may comprise a plurality of repeating tongues pairs separated by the opening 1118, to accommodate a plurality of containers 1104.

The rack 1112 may comprise a base 1112 that may be coupled to a mounting bracket 1116. The mounting bracket may be attached to the base 1112 at an angle (e.g., between 20 deg and 70 deg). The tongues 1108, 1110 may be vertically aligned perpendicular to the base 1112, and opposing edges of the tongues are parallel to each other. The base and each tongue may form a right angle. In this manner, when mounted via the mounting bracket 1116, the rack may be held at an angle to allow for improved visibility and access to the user for inserting and removing a container. Additionally, the rack may be placed on a flat surface on its base, where the tongue and groove connection is configured to sit the base of the container at the same surface level of the rack base 1112 when the tongue groove connection bottoms out, thereby allowing the combination container and rack system to be stable on the surface without tilting, even when used as a standalone rack. In an example, the rack 1112 may be formed from a single member of sufficiently stiff and strong material (e.g., a metal alloy, a plastic, wood or wood composite, carbon fiber composite, etc.).

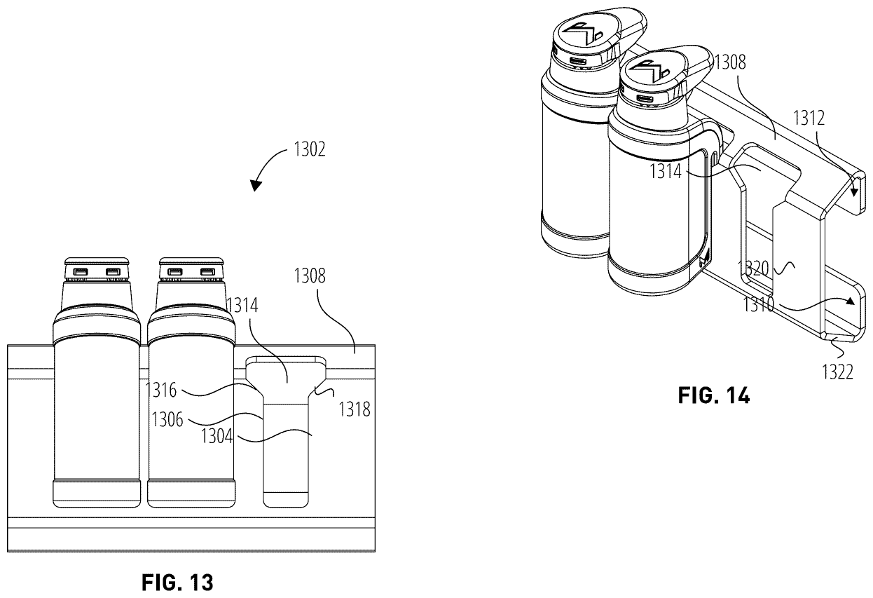

FIG. 13 and FIG. 14 show an example container and rack system 1302, in accordance with an embodiment. The rack system 1302 may comprise a plurality of holding positions for the described container, each holding position comprising tongues 1306 and 1304, having straight vertical edges that are parallel to each other, as is also the case in other embodiments of the rack. In this example, each tongue edge may transition to an angled edge 1316 and 1318 which increases the size of the opening 1314 arranged at the tops of the tongues, to make it easier to insert the container through the opening 1314 to be held in the respective hole ding position. In an embodiment, although not shown as such, the rack 1112 in FIG. 11 and FIG. 12 may also comprise angled edges at each respective tongue.

In an embodiment, the rack 1302 may be formed from a may be formed from a single member of sufficiently stiff and strong material (e.g., a metal alloy, a plastic, wood or wood composite, carbon fiber composite, etc.). In an example, it may comprise five flat planes, connected to each other at angles. A first plane 1312 may be flush vertical on a back side of the rack 1302, a second plane 1308 may be connected between the first plane 1312 and a third plane 1320. The plane surface 1308 may comprise a portion of each opening 1312 that is at a top region of each of the tongues 1304, 1306. The third plane may comprise the tongues 1306, 1304. A plane surface 1322 may be connected to and between the third plane 1320 and a fifth plane 1310. The fifth plane 1310 and first plane 1312 may be co-located on a same three-dimensional plane, so that when mounted, both planes each sit flush against the mounting surface (e.g., a wall).

Features described with respect to one rack may be combined with features of another rack, without departing from the scope of the present disclosure.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

What is claimed is:

1. An ink container, comprising:
a body, carrying tattoo ink in an interior of the body, wherein the body comprises an opening through a neck of the body; and
a cap attached to the neck, wherein the cap comprises a first portion and a second portion, to pivot about a fulcrum, wherein in response to a force on the first portion, the second portion of the cap moves to uncover the opening to the body, allowing the tattoo ink to flow out of the body through the neck.

2. The ink container of claim 1, wherein the neck comprises a raised tab, arranged on the neck to apply a holding force to the cap when the cap is in a closed position.

3. The ink container of claim 2, wherein the raised tab comprises an arc shape, wherein the arc shape is complementary in shape to one or more sidewalls of the cap.

4. The ink container of claim 3, wherein the raised tab comprises at least 0.5 mm in height and at least 3 mm in length, or at least 20 mm in length, or at least 25 mm in length.

5. The ink container of claim 3, wherein the neck comprises an elongated spout that extends from the neck and into a recess of the cap, formed by the one or more sidewalls, when the cap is in a closed position.

6. The ink container of claim 5, wherein the recess of the cap comprises a D-shape, and the raised tab is complementary in shape to an interior curved portion of the D-shape, to apply the holding force against the interior curved portion.

7. The ink container of claim 5, wherein the spout comprises a height of at least 2.5 mm, or at least 4 mm, and the spout comprises an opening of at least 3 mm in diameter, or at least 4 mm in diameter.

8. The ink container of claim 5, wherein the cap comprises a collar that is raised on an interior surface within the recess, wherein the collar is complementary in shape with an opening of the spout, and aligned in position with the spout to seal the opening of the spout when the cap is in the closed position.

9. The ink container of claim 1, wherein the fulcrum is fixed to the neck and comprises at least one bracket with a pin or socket that mates with a second socket or second pin of the cap.

10. The ink container of claim 9, wherein the at least one bracket comprises a first bracket fixed to the neck and a second bracket fixed to the neck, wherein the first bracket and the second bracket are parallel to each other.

11. The ink container of claim 1, wherein the second portion of the cap comprises a downward sloping surface and the first portion of the cap comprises a horizontal surface, relative to a base of the ink container.

12. The ink container of claim 11, wherein the downward sloping surface comprises a length of at least 5 mm, or at least 8 mm, or at least 10 mm.

13. The ink container of claim 1, wherein the body comprises one or more grooves arranged along a vertical axis of the ink container.

14. The ink container of claim 13, wherein the one or more grooves comprises a first groove and a second groove, the first groove being arranged on a first side of the body, the second groove being arranged on a second side of the body, wherein the first side and the second side are opposite facing.

15. The ink container of claim 14, wherein a bottom end of each of the first groove and the second groove is open at a bottom edge of the body.

16. The ink container of claim 15, wherein a top end of each of the first groove and the second groove come to a respective stop formed by a surface of the body away from an edge of the body.

17. The ink container of claim 13, wherein the one or more grooves are complimentary in shape to one or more tongues that are vertically aligned on a rack, to hold the ink container with a vertical orientation on the rack.

18. The ink container of claim 1, wherein a base of the body comprises a round side between the first side and the second side, and a flat edge between the first side and the second side, wherein the flat side is located opposite of the round side.

19. The ink container of claim 18, wherein the second portion of the cap is located on a same side of the ink container as the flat side, and the first portion of the cap is located on a same side of the ink container as the round side.

20. The ink container of claim 1, wherein a total height of the ink container comprises a range of 50 mm to 90 mm, or a range of 60 mm to 80 mm, or a range of 70 mm to 75 mm.

21. The ink container of claim 1, wherein the neck and the body comprise a single monolithic form and the cap comprises a second single monolithic form.
